(19) United States
(12) Patent Application Publication
(10) Pub. No.: US 2026/0010726 A1
(43) Pub. Date: Jan. 8, 2026

(54) TASK PROCESSING METHOD AND APPARATUS, ELECTRONIC DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventor: Gang LIU, Shenzhen (CN)

(21) Appl. No.: 19/324,084

(22) Filed: Sep. 9, 2025

Related U.S. Application Data
(63) Continuation of application No. PCT/CN2023/135450, filed on Nov. 30, 2023.

(30) Foreign Application Priority Data
Jul. 31, 2023 (CN) 202310950974.5

(51) Int. Cl. G06F 40/30; G06F 40/205; G06F 40/253; G06N 20/00

(52) U.S. Cl. CPC G06F 40/30; G06F 40/205; G06F 40/253; G06N 20/00

(57) ABSTRACT

A task processing method performed by an electronic device includes generating, based on task prompt information corresponding to a target task in a service scenario, a system interaction parameter corresponding to the target task. The task prompt information describes the target task in a form of natural language, and the system interaction parameter describes the target task in a form of machine instructions. The method further includes invoking a task system of the target task to process the system interaction parameter, and determining a processing result corresponding to the target task based on output information of the task system for the system interaction parameter.

### CROSS-REFERENCE TO RELATED APPLICATIONS

This application is a continuation of International Application No. PCT/CN2023/135450, filed on November 30, 2023, which claims priority to Chinese Patent Application No. 202310950974.5 filed on July 31, 2023, the entire contents of both of which are incorporated herein by reference.

### FIELD OF THE TECHNOLOGY

This application relates to artificial intelligence technologies, and in particular, to a task processing method and apparatus, an electronic device, a computer-readable storage medium, and a computer program product.

### BACKGROUND OF THE DISCLOSURE

With the rapid development of mobile Internet, various social application platforms have divided their services into a plurality of service scenarios, for example, a social networking scenario, an interest expansion scenario, and a content promotion scenario. Each service scenario involves service-related information, and task processing needs to be performed on the information in each service scenario.

In the related art, to perform task processing in different service scenarios, a processing interface of a graph neural network is usually invoked by using different code, to perform corresponding task processing. However, code development increases time consumption, which affects the efficiency of task processing, and further increases the complexity of task processing.

### SUMMARY

In accordance with the disclosure, there is provided a task processing method performed by an electronic device and including generating, based on task prompt information corresponding to a target task in a service scenario, a system interaction parameter corresponding to the target task. The task prompt information describes the target task in a form of natural language, and the system interaction parameter describes the target task in a form of machine instructions. The method further includes invoking a task system of the target task to process the system interaction parameter, and determining a processing result corresponding to the target task based on output information of the task system for the system interaction parameter.

Also in accordance with the disclosure, there is provided an electronic device including a memory storing a computer program or computer-executable instructions, and a processor configured to execute the computer program or the computer-executable instructions to generate, based on task prompt information corresponding to a target task in a service scenario, a system interaction parameter corresponding to the target task. The task prompt information describes the target task in a form of natural language, and the system interaction parameter describes the target task in a form of machine instructions. The processor is further configured to execute the computer program or the computer-executable instructions to invoke a task system of the target task to process the system interaction parameter, and determine a processing result corresponding to the target task based on output information of the task system for the system interaction parameter.

Also in accordance with the disclosure, there is provided a non-transitory computer-readable storage medium storing a computer program or computer-executable instructions that, when executed by a processor, cause an electronic device including the processor to generate, based on task prompt information corresponding to a target task in a service scenario, a system interaction parameter corresponding to the target task. The task prompt information describes the target task in a form of natural language, and the system interaction parameter describes the target task in a form of machine instructions. The computer program or the computer-executable instructions, when executed by the processor, further cause the electronic device to invoke a task system of the target task to process the system interaction parameter, and determine a processing result corresponding to the target task based on output information of the task system for the system interaction parameter.

### BRIEF DESCRIPTION OF THE DRAWINGS

FIG. 1 is a schematic diagram showing an architecture of a task processing system according to an embodiment of this application.

FIG. 2 is a schematic structural diagram of a server in FIG. 1 according to an embodiment of this application.

FIG. 3 is a schematic flowchart 1 of a task processing method according to an embodiment of this application.

FIG. 4 is a schematic flowchart 2 of a task processing method according to an embodiment of this application.

FIG. 5 is a schematic flowchart 3 of a task processing method according to an embodiment of this application.

FIG. 6 is a schematic flowchart 4 of a task processing method according to an embodiment of this application.

FIG. 7 is a schematic diagram showing a system architecture for expansion of social relationships and points of interest according to an embodiment of this application.

FIG. 8 is a schematic diagram showing collaborative working between a large language pre-trained model and a social relationship system model according to an embodiment of this application.

### DESCRIPTION OF EMBODIMENTS

To make the objectives, technical solutions, and advantages of this application clearer, the following further describes this application in detail with reference to the accompanying drawings. The described embodiments are not to be considered as a limitation to this application. All other embodiments obtained by a person of ordinary skill in the art without creative efforts shall fall within the scope of this application.

In the following descriptions, related "some embodiments" describe a subset of all possible embodiments. However, the "some embodiments" may be the same subset or different subsets of all the possible embodiments, and may be combined with each other without conflict.

In embodiments of this application, the term "module" or "unit" refers to a computer program having a predetermined function or a part of a computer program, and works together with other related parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may include the whole or a part of a function of the module or unit.

Unless otherwise defined, meanings of all technical and scientific terms used in this specification are the same as those generally understood by a person skilled in the art to which this application belongs. Terms used in this specification are merely intended to describe objectives of the embodiments of this application, but are not intended to limit this application.

Before the embodiments of this application are further described in detail, nouns and terms involved in the embodiments of this application are described. The nouns and terms provided in the embodiments of this application are applicable to the following explanations.

1) Artificial intelligence (AI) is a theory, method, technology, and application system that uses a digital computer or a machine controlled by the digital computer to simulate, extend, and expand human intelligence, perceive an environment, obtain knowledge, and use knowledge to obtain an optimal result. In other words, Al is a comprehensive technology in computer science. This technology is configured to understand the essence of intelligence and produce a new intelligent machine that can react in a manner similar to human intelligence. The Al is to study design principles and implementation methods of various intelligent machines, to enable a machine to have functions of perception, reasoning, and decision-making.

2) Natural language processing (NLP) is a direction in the fields of computer science and Al, and is configured to implement various theories and methods for effective communication between human and computers by using natural language. NLP relates to natural language, that is, languages used by people in daily life, and NLP is closely related to linguistic studies. NLP technologies generally include text processing, semantic understanding, machine translation, robot question answering, knowledge graphs and other technologies.

3) Machine learning (ML) is a multi-field interdiscipline, and relates to a plurality of disciplines such as the probability theory, statistics, the approximation theory, convex analysis, and the algorithm complexity theory. ML is configured to determine how a computer simulates or implements a human learning behavior to obtain new knowledge or skills, and reorganize an existing knowledge structure, so as to keep improving its performance. ML is the core of Al, is a basic way to make the computer intelligent, and is applied to various fields of Al. ML and deep learning generally include technologies such as an artificial neural network, a belief network, reinforcement learning, transfer learning, inductive learning, and learning from demonstrations. A pre-trained model is a latest development result of deep learning, and combines the foregoing technologies.

4) A large language model (LLM) refers to a computer model capable of processing and generating natural language, and is also referred to as a pre-trained model. After fine tuning, LLM may be widely applied to downstream tasks. LLM can predict a next string or sentence by learning statistic rules and semantic information of language data. With continuous expansion of an input data set and parameter space, a capability of LLM is improved accordingly.

5) Instruction tuning refers to separately generating instructions for each task, performing fine tuning on several tasks (Full-Shot, that is, fine tuning is performed on all parameters of a pre-trained model), and then evaluating generalization performance on a specific task. Parameters of the pre-trained model are obtained by training on a large quantity (greater than a specified quantity of data sets) of disclosed NLP task data sets, to improve an understanding capability of the model. By providing an instruction, the model can understand and make correct feedback.

6) Prompt learning refers to performing information enhancement by using "prompt information" in a case that a structure and parameters of the pre-trained model are not significantly changed (a change amount is less than a specified data amount), thereby improving an effect of the model. Prompt learning is type of instructions for tasks, and is also a reuse for pre-trained objectives. It enhances parameter validity by generating separate prompt templates, and tuning and evaluating the prompt templates on each task.

7) Reinforcement learning with human feedback (RLHF) is an extension of reinforcement learning, and is configured for incorporating human feedback into a training process, to provide a natural and user-friendly interactive learning process for a machine. In addition to a reward signal, RLHF obtains the feedback from humans, to improve the perspective and efficiency of learning knowledge. The process is similar to a manner in which a human learns from professional knowledge of another human.

RLHF can receive instructions in a form of natural language, to perform task processing by using the instructions in the form of natural language, so that the electronic device can embed decision-making elements in human experience. As an effective alignment technology, RLHF can improve the quality of content generated by LLM, and improve the information integrity.

8) Recommended content refers to content recommended to an account, and may include images and texts, pictures, short videos (generally refer to videos with a video duration is less than a preset duration), or the like. The images and texts may be actively edited and released by a creator, and the short videos may be provided by a content producer of professional generated content (PGC) or user generated content (UGC). The recommended content is finally provided to users in a form of Feeds stream (information stream) based on points of interest of the users.

9) Professional generated content refers to content produced by an institution or an organization configured for generating content.

10) User generated content refers to content originally created by a user.

11) Social distribution refers to recommending content to a recommended object by using a social media platform, a social application, or another social network. Through social distribution, the information stream may be recommended to another recommended object and a recommended object set that interact with the recommended obj ect, to improve the exposure and visibility of the information stream. Social distribution may be implemented based on factors such as interests, features, and social relationships of the recommended object, or may be implemented through sharing by the recommended object.

With the rapid development of mobile Internet, various social application platforms have divided their services into a plurality of service scenarios, for example, a social networking scenario, an interest expansion scenario, and a content promotion scenario. Each service scenario involves service-related information, and task processing needs to be performed on the information in each service scenario. For example, a friend recommendation task in the social networking scenario requires determining information such as an object that a target object may know or be interested. An information recommendation task in the interest expansion scenario requires selecting information that a target object may be interested from massive (greater than a specified amount of information) short videos and image and text information to recommend to the target object. A targeted delivery task in the content promotion scenario requires determining a suitable delivery object for content to be promoted.

In the related art, when task processing is performed on information in the service scenario, usually, after data (such as an interest tag of the target object and an information content tag) of different service scenarios is obtained, processing is first performed based on the service scenarios. Then, a graph network is constructed to integrate the data of different service scenarios. A feature representation of an interest and a social relationship of the target object is extracted from the graph network by using a graph neural network (GNN) algorithm, such as a neighbor sampling algorithm, an aggregation algorithm, or an update algorithm. The feature is inputted into application-layer algorithm models corresponding to different service scenarios, such as a recall model of a recommendation system and a feature matching model of a search system, for subsequent processing. For example, a short video that the target object may be interested is recalled based on the feature representation, or a target object to be pushed in a targeted manner is determined based on the feature representation for specific promotion information.

In the related art, for specific tasks in the different service scenarios, code development is usually specially required to invoke a graph neural network processing interface, to perform corresponding processing. However, code development requires a specific amount of time to complete. If a code development manner is used for the service scenario to implement corresponding task processing, it not only affects the efficiency of task processing, but also increases the operational complexity of task processing.

Further, different tasks may require processing different data. For example, some tasks require processing interest data of the target object, and some other tasks require processing social relationship data of the target object. In addition, the data processing manners may also vary. For example, some tasks require obtaining a neighboring node, and some other tasks require obtaining a vector representation. It can be learned that, different tasks may involve different service scenarios and data. If different service scenarios and different data are combined, an amount of data in the combined result is increased. However, separately performing code development for each combination deviates from actual implementation processing, thereby affecting the executability of task processing.

In addition, the same data in different service scenarios may have different meanings. For example, in a gaming forum scenario, essence refers to highest-quality forum posts, and in a content promotion scenario, essence may refer to skincare products. In the gaming forum scenario, diamond refers to a game rank, and in the interest expansion scenario, diamond is a gemstone type. It can be learned that, meanings of the same data in different service scenarios are difference. As a result, integrating data in different service scenarios by constructing a graph network cannot eliminate a semantic difference between data in different service scenarios, which affects the accuracy of task processing.

Finally, the feature representation extracted from the graph network is an implicit vector representation that lacks an intuitive semantic feature. As a result, the feature representation extracted from the graph network is not suitable for being directly used in some tasks (for example, tasks that need to be displayed and described to humans), thereby reducing the quantity of task processing types that can be performed on data in the service scenario.

Based on this, the embodiments of this application provide a task processing method and apparatus, an electronic device, a computer-readable storage medium, and a computer program product, which can improve the efficiency, accuracy, executability, and applicability of task processing, and can reduce the complexity of task processing. The following describes an exemplary application of an electronic device provided in the embodiments of this application. The electronic device provided in the embodiments of this application may be implemented as various types of terminals such as a notebook computer, a tablet computer, a desktop computer, a set-top box, a mobile device (for example, a mobile phone, a portable music player, a personal digital assistant, a dedicated messaging device, or a portable game device), or may be implemented as a server. An exemplary application in which the electronic device is implemented as a server is described below.

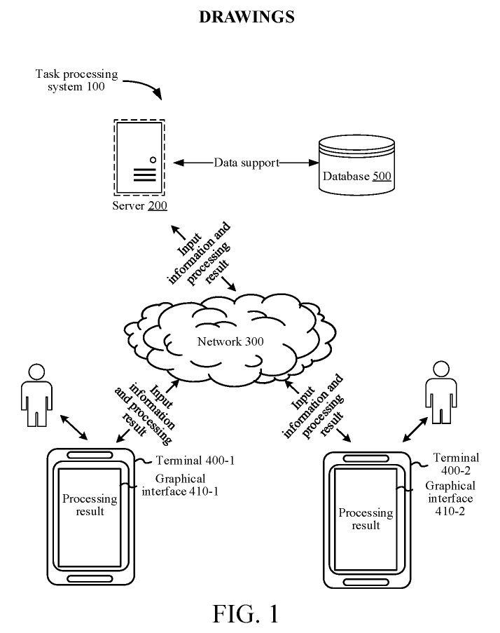

FIG. 1 is a schematic diagram showing an architecture of a task processing system according to an embodiment of this application. To support a task processing application, in the task processing system 100, terminals (a terminal 400-1 and a terminal 400-2 are shown as an example) are connected to a server 200 through a network 300. The network 300 may be a wide area network or a local area network, or a combination thereof. The task processing system 100 is further provided with a database 500 configured to provide data support to the server 200. The database 500 may be independent of the server 200, or may be configured in the server 200. FIG. 1 shows a case in which the database 500 is independent of the server 200.

The terminal 400-1 and the terminal 400-2 are configured to respectively obtain input information in response to an input operation of an operator on an information input interface displayed on a graphical interface, and transmit the input information to the server 200 through the network 300.

The server 200 is configured to: determine corresponding task prompt information for a target task in a service scenario from the input information, and generate a system interaction parameter corresponding to the target task based on the task prompt information corresponding to the target task in the service scenario, the task prompt information being configured for describing the target task in a form of natural language, and the system interaction parameter being configured for describing the target task in a form of machine instructions; invoke a task system of the target task, to process the system interaction parameter; and determine a processing result corresponding to the target task based on output information of the task system of the target task for the system interaction parameter, and return the processing result to the terminal 400-1 and the terminal 400-2 through the network 300.

The terminal 400-1 and the terminal 400-2 are further respectively configured to display the processing result on a graphical interface 410-1 and a graphical interface 410-2.

The embodiments of this application may be implemented by means of cloud technology, and the cloud technology is a hosting technology that unifies a series of resources such as hardware, software, and networks in a wide area network or a local area network to implement computing, storage, processing, and sharing of data.

The cloud technology is a collective name of a network technology, an information technology, an integration technology, a management platform technology, an application technology, and the like based on an application of a cloud computing business mode, and may form a resource pool, which is used as required, and is flexible and convenient. Computing resources and storage resources required for a system backend service of a technical network can be implemented through cloud computing.

For example, the server 200 may be an independent physical server, or may be a server cluster formed by a plurality of physical servers or a distributed system, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform. The terminal 400-1 and the terminal 400-2 may be smartphones, tablet computers, notebook computers, desktop computers, smart speakers, smartwatches, smart household appliances, in-vehicle terminals, or the like, but are not limited thereto. The terminal and the server may be directly or indirectly connected in a wired or wireless communication manner. This is not limited in the embodiments of this application.

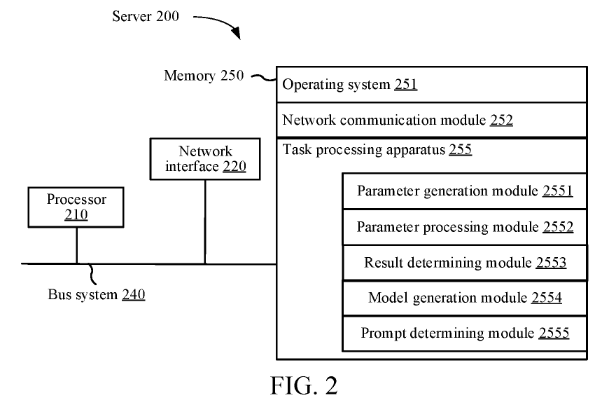

FIG. 2 is a schematic structural diagram of a server in FIG. 1 (an implementation of an electronic device) according to an embodiment of this application. The server 200 shown in FIG. 2 includes: at least one processor 210, a memory 250, and at least one network interface 220. All components in the server 200 are coupled together by using a bus system 240. The bus system 240 is configured to implement connection and communication between the components. In addition to a data bus, the bus system 240 further includes a power bus, a control bus, and a state signal bus. However, for ease of clear description, all types of buses are marked as the bus system 240 in FIG. 2.

The processor 210 may be an integrated circuit chip having a signal processing capability, for example, a general purpose processor, a digital signal processor (DSP), or another programmable logic device, discrete gate, transistor logical device, or discrete hardware component. The general purpose processor may be a microprocessor, any conventional processor, or the like.

The memory 250 may be a removable memory, a non-removable memory, or a combination thereof. Exemplary hardware devices include a solid-state memory, a hard disk drive, an optical disc driver, and the like. In some embodiments, the memory 250 includes one or more storage devices away from the processor 210 in a physical position.

The memory 250 includes a volatile memory or a non-volatile memory, or may include both a volatile memory and a non-volatile memory. The non-volatile memory may be a read only memory (ROM). The volatile memory may be a random access memory (RAM). The memory 250 described in the embodiments of this application is to include any other suitable type of memories.

In some embodiments, the memory 250 can store data to support various operations. Examples of the data include a program, a module, and a data structure, or a subset or a superset thereof, which are described below by using examples.

An operating system 251 includes a system program configured to process various basic system services and perform a hardware-related task, such as a framework layer, a core library layer, or a driver layer, and is configured to implement various basic services and process a hardware-based task.

A network communication module 252 is configured to reach another computing device through one or more (wired or wireless) network interfaces 220. Exemplary network interfaces 220 include: Bluetooth, wireless fidelity (Wi-Fi), universal serial bus (USB), and the like.

In some embodiments, the task processing apparatus provided in the embodiments of this application may be implemented by using software. FIG. 2 shows a task processing apparatus 255 stored in the memory 250, which may be software in a form of a program and a plug-in, including the following software modules: a parameter generation module 2551, a parameter processing module 2552, a result determining module 2553, a model generation module 2554, and a prompt determining module 2555. These modules are logical modules, and therefore may be randomly combined or further split based on implemented functions. Functions of the modules are described below.

In some embodiments, the task processing apparatus provided in the embodiments of this application may be implemented by using hardware. For example, the task processing apparatus provided in the embodiments of this application may be a processor in a form of a hardware decoding processor, programmed to perform the task processing method provided in the embodiments of this application. For example, the processor in the form of a hardware decoding processor may use one or more application specific integrated circuits (ASICs), a DSP, a programmable logic device (PLD), a complex programmable logic device (CPLD), a field- programmable gate array (FPGA), or another electronic element.

In some embodiments, the terminal or the server (both possible implementations of the electronic device) may implement the task processing method provided in the embodiments of this application by running a computer program. For example, the computer program may be a native program or a software module in an operating system; may be a native application (APP), that is, a program that needs to be installed in an operating system to run, for example, an instant messaging APP; or may be a mini program embedded into any APP, that is, a program that only needs to be downloaded into a browser environment to run. In conclusion, the computer program may be any form of an application, a module, or a plug-in.

The embodiments of this application may be applied to task processing scenarios such as artificial intelligence, big data, and cloud computing. The following describes the task processing method provided in the embodiments of this application. As described above, an electronic device for implementing the task processing method in the embodiments of this application may be implemented as a terminal, a server, or a combination thereof. Therefore, an execution body of each operation is not repeatedly described below.

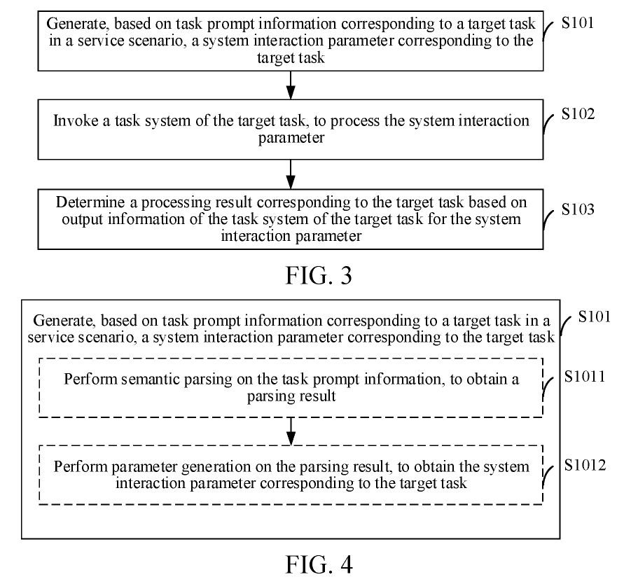

FIG. 3 is a schematic flowchart 1 of a task processing method according to an embodiment of this application. Description is provided in combination with operations shown in FIG. 3.

S101. Generate, based on task prompt information corresponding to a target task in a service scenario, a system interaction parameter corresponding to the target task.

The embodiments of this application are implemented in a scenario in which the target task is processed in the service scenario. In this embodiment of this application, after obtaining the task prompt information corresponding to the target task, the electronic device converts the task prompt information, to obtain a system interaction parameter that can be understood by machines.

In other words, in this embodiment of this application, the system interaction parameter is configured for describing the target task in a form of machine instructions. That is, the task prompt information is configured for describing the target task in a form of natural language. Content such as specific processing to be implemented in the target task and task requirements of the target task may all be embodied by using the natural language. Therefore, the task prompt information has certain linguistic features, and is information that can be understood by humans. The system interaction parameter is configured for describing the target task in the form of machine instructions, so that after this operation, content such as specific processing to be implemented in the target task and task requirements of the target task can be embodied in an instruction parameter that can be understood by machines. In this way, it is convenient for a task system corresponding to the target task to process the target task.

In other words, in this embodiment of this application, the electronic device converts the task prompt information in the form of natural language, that is, the task prompt information that can be understood by humans, into the instruction parameter that can be understood by machines. The instruction parameter has an effect similar to code developed for the target task, and is configured for invoking the task system to perform corresponding task processing.

The service scenario in this embodiment of this application may be any scenario in which corresponding data can be generated based on a service operation, or data is associated with users. For example, the service scenario may be a social networking scenario (for example, friend recommendation in a social application), a gaming forum scenario (for example, discussion in game tactics and game teams on game channels of a website), an interest expansion scenario (for example, interest-based content recommendation in a social application), or a content promotion scenario (for example, a splash advertisement). This is not limited in the embodiments of this application.

The target task in the embodiments of this application may be set based on a requirement of an actual service scenario. This is not limited in the embodiments of this application. For example, when the service scenario is the social networking scenario, the target task may be to recommend an account that a target account may be interested, or an account nearby (within a specified range); when the service scenario is the gaming forum scenario, the target task may be to perform sensitive word detection on image and text content uploaded by an account; when the service scenario is the interest expansion scenario, the target task may be to select, for an account, short videos that the account is interested; and when the service scenario is the content promotion scenario, the target task may be to determine a suitable user for an advertisement, for targeted delivery.

The target task may be a manually specified task, for example, a task specified by an operator for a service scenario, or may be a task determined by the electronic device based on specified running time of different tasks. This is not limited in the embodiments of this application.

In the embodiments of this application, the electronic device may generate the system interaction parameter corresponding to the target task in a plurality of manners.

FIG. 4 is a schematic flowchart 2 of a task processing method according to an embodiment of this application. In some embodiments of this application, S101 of generating, based on task prompt information corresponding to a target task in a service scenario, a system interaction parameter corresponding to the target task in FIG. 3 may be implemented through the following processing (S1011 and S1012).

S1011. Perform semantic parsing on the task prompt information, to obtain a parsing result.

In the embodiments of this application, the electronic device may perform semantic parsing the task prompt information based on semantic corpora in the service scenario, or may directly perform semantic parsing on the task prompt information by using an obtained natural language processing model. A semantic parsing capability of the natural language processing model is achieved after pre-training is performed by using a large amount (greater than a specified data amount) of corpus data, and a quantity of parameters of the natural language processing model is greater than a quantity threshold. It can be learned that, the natural language processing model in the embodiments of this application is essentially a pre-trained large language model with a large quantity of parameters. In this way, the natural language processing model has a capability of eliminating semantic ambiguity of the same data in different service scenarios. Therefore, semantic parsing is performed on the task prompt information by using the natural language processing model, to eliminate semantic differences of the same data in different service scenarios, which can improve the accuracy of the parsing result.

S1012. Perform parameter generation on the parsing result, to obtain the system interaction parameter corresponding to the target task.

The electronic device clarifies, by using the parsing result, a specific requirement expressed in the task prompt information of the target task, and creates a parameter instruction based on the requirement. The obtained parameter instruction is the system interaction parameter that can be understood by the task system of the target task.

In some embodiments of this application, S101 of generating, based on task prompt information corresponding to a target task in a service scenario, a system interaction parameter corresponding to the target task in may further be implemented by using the following processing: matching the task prompt information with a plurality of pieces of preset prompt information corresponding to a plurality of preset interaction parameters, and using a preset interaction parameter corresponding to the matching (e.g., where similarity reaches a threshold) preset prompt information as the system interaction parameter, to complete generation of the system interaction parameter corresponding to the target task.

S102. Invoke a task system of the target task, to process the system interaction parameter.

The electronic device invokes the task system corresponding to the target task, and transmits the system interaction parameter to the task system. Then, the electronic device parses the system interaction parameter by using the task system, to determine an intention and a requirement of the target task, and starts corresponding processing.

The task system of the target task is a system associated with the target task. When the target task is to recommend an account that a target account may be interested to the target account, the task system is a social relationship parsing system; when the target task is to perform sensitive word detection on image and text content uploaded by an account, the task system is a sensitive word detection system; and when the target task is to select short videos that an account is interested, the task system is a short video recall system and sorting system. The foregoing systems may be implemented based on the graph neural network, or may be implemented based on a model such as a convolutional neural network or a recurrent neural network. This is not limited in the embodiments of this application.

S103. Determine a processing result corresponding to the target task based on output information of the task system of the target task for the system interaction parameter.

After the task system of the target task completes processing on the system interaction parameter, corresponding output information is generated for the system interaction parameter. The electronic device performs result generation on the target task based on the obtained output information, to obtain the processing result corresponding to the target task, to complete a task processing procedure for the target task in the service scenario.

In some embodiments of this application, S103 of determining a processing result corresponding to the target task based on output information of the task system of the target task for the system interaction parameter in FIG. 3 may be implemented by using the following processing: generating a matching text for the output information of the task system of the target task for the system interaction parameter; and determining the matching text as the processing result corresponding to the target task.

The matching text is configured for describing the output information in the form of natural language. In other words, the electronic device may describe the output information in the form of natural language to obtain the matching text, or may directly invoke the natural language processing model to perform text generation on the output information, and use the generated matching text as a final processing result for the target task. In this way, the processing result for the target task can have intuitive and human-understandable semantic information, thereby facilitating interaction with humans.

In some embodiments of this application, S103 of determining a processing result corresponding to the target task based on output information of the task system of the target task for the system interaction parameter in FIG. 3 may further be implemented by using the following processing: directly determining the output information as the processing result corresponding to the target task.

In other words, the electronic device may directly use the output information of the task system of the target task for the system interaction parameter as the processing result corresponding to the target task without performing any processing. In this way, the generation process of the processing result is simpler and easier to implement.

In the embodiments of this application, the system interaction parameter may include one interaction sub-parameter, that is, the natural language processing model generates one interaction sub-parameter for the task prompt information. In this case, the task system of the target task may perform information generation on the interaction sub-parameter and output information, so that the obtained output information includes one piece of output sub- information. The system interaction parameter may further include a plurality of interaction sub- parameters. This may be because the natural language processing model generates corresponding interaction sub-parameters for all possible semantics of the task prompt information. In this case, the task system of the target task performs information generation on each interaction sub- parameter and outputs information, so that the output information includes a plurality of pieces of output sub-information.

In some embodiments of this application, the output information includes a plurality of pieces of output sub-information. In this case, S103 of determining a processing result corresponding to the target task based on output information of the task system of the target task for the system interaction parameter in FIG. 3 may be implemented by using the following processing: generating evaluation information for each piece of output sub- information; and filtering a plurality of pieces of output sub-information based on the evaluation information, and determining the processing result corresponding to the target task based on the selected output sub-information.

In other words, when the task system outputs the plurality of pieces of output sub- information, the electronic device determines, based on evaluation information of each piece of output sub-information, whether each piece of output sub-information is information really needed by the target task, to determine whether to use the output sub-information to determine the final processing result for the target task. The electronic device may select output sub- information with the highest evaluation information, to generate the processing result, or may select output sub-information with evaluation information higher than an evaluation threshold, to generate the processing result.

In the embodiments of this application, the evaluation information may be generated for the output sub-information by using an evaluation model, and the evaluation model may be obtained by using the following processing: generating, based on training prompt information corresponding to a training task in the service scenario, a training interaction parameter corresponding to the training task; invoking a task system of the training task, to process the training interaction parameter; determining, based on a plurality of pieces of training output sub-information of the task system of the training task for the training interaction parameter, a plurality of training processing results corresponding to the training task; and based on a plurality of pieces of benchmark scoring information of the plurality of training processing results and a plurality of pieces of training scoring information generated by an initial model for the plurality of training processing results, training the initial model to adjust parameters of the initial model until the end of training, to obtain the evaluation model.

The training task may be the same as the target task in type, or may be another type of task that belongs to the same service scenario as the target task. This is not limited in the embodiments of this application. Generation processes of the training interaction parameter and the training processing result are respectively similar to generation processes of the system interaction parameter and the processing result, and details are not described herein again.

The benchmark scoring information of the training processing result is scoring information generated by humans for the training processing result, so that the benchmark scoring information includes information about whether the training processing result meets human expectations. Therefore, a difference between the benchmark scoring information and the training scoring information is actually a difference between human expectations and predicted results of machines. Based on this, the electronic device may perform parameter adjustment on the initial model by using the difference between the benchmark scoring information and the training scoring information, so that the initial model can learn human knowledge, that is, achieving the effect of performing parameter adjustment on the initial model by using the human knowledge. Therefore, based on the obtained evaluation model, an output of the task system can be aligned with human expectations, so that the final processing result meets human expectations.

Compared with the related art in which task processing can only be implemented when dedicated code development is performed for tasks, the electronic device in the embodiments of this application first generates the system interaction parameter in the form of machine instructions for the task prompt information of the target task in the form of natural language, that is, converting task prompt information that can be understood by humans into parameter instructions that can be understood by machines; then invokes the task system of the target task, to read the system interaction parameter and perform corresponding processing; and finally generates the processing result for the target task based on the output information of the task system for the system interaction parameter, to complete task processing of the target task. In this way, task processing on the target task can be triggered and completed based on only natural language instructions, eliminating the need for code development for the target task. This not only reduces the time required for code development, and enables faster initiation of task processing on the target task, thereby improving the efficiency of task processing, but also reduces the operation difficulty of task processing as the natural language instructions are easier to generate and process thereby further compared with code.

Further, in the embodiments of this application, when a combination of the service scenario and data changes, that is, a task that needs to be processed changes, only the task prompt information of the natural language needs to be changed. In this way, various tasks can be normally processed, thereby expanding the range of tasks that can be processed.

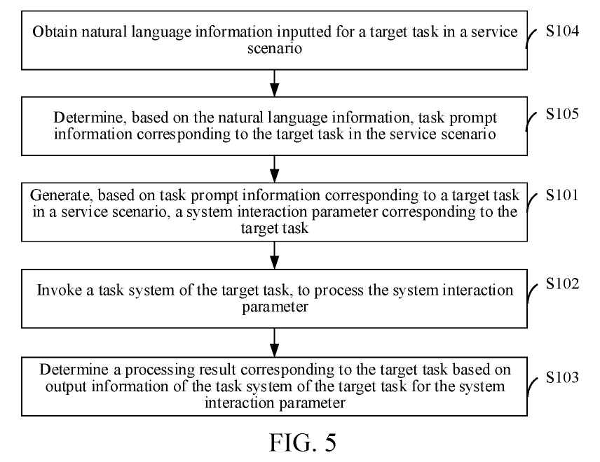

FIG. 5 is a schematic flowchart 3 of a task processing method according to an embodiment of this application based on the process shown in FIG. 3. In some embodiments of this application, before S101 of generating, based on task prompt information corresponding to a target task in a service scenario, a system interaction parameter corresponding to the target task in FIG. 3, the task processing method may further include the following processing (S104 and S105).

S104. Obtain natural language information inputted for the target task in the service scenario.

In the embodiments of this application, the electronic device may determine, based on the natural language information inputted for the target task, the task prompt information corresponding to the target task. Herein, the electronic device first detects an information input operation performed on the target task on an input device. The information input operation is, for example, an input operation performed by a human (which may be an operator or a common user, specifically depending on the service scenario) on a keyboard or a touchscreen. When detecting the information input operation and determining that inputted information is of a natural language type, the electronic device obtains the inputted information from the input device, and the information is natural language information.

For example, when detecting that the human inputs a sentence "Recommend alumni from the same school to me" on the touchscreen, the electronic device determines the sentence as natural language information.

S105. Determine, based on the natural language information, the task prompt information corresponding to the target task in the service scenario.

After obtaining the natural language information, the electronic device may directly determine the obtained natural language information as the task prompt information corresponding to the target task, or may refine the natural language information, for example, extracting key strings or removing redundant content, determine the refined natural language information as the task prompt information of the target task, or may perform semantic extraction on the natural language, and re-integrate the extracted semantic information and basic attribute information of a target object into natural language instructions. The instructions are the final task prompt information.

For example, the electronic device may extract, from "Recommend alumni from the same school to me," that the to-be-processed task is searching for an account that belongs to the same school as a target account, and integrate the information with basic attribute information (for example, an account identifier UID) of the target account, to obtain the task prompt information in the form of natural language "Account UIDs belonging to the same school as the account UID=XXX."

In the embodiments of this application, the electronic device may obtain the task prompt information of the target task from the inputted natural language information, so that the task prompt information can accurately describe the to-be-processed task.

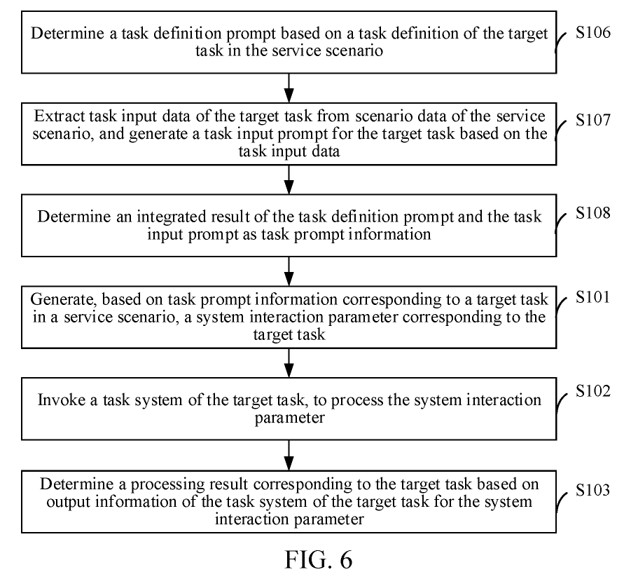

FIG. 6 is a schematic flowchart 4 of a task processing method according to an embodiment of this application based on FIG. 3. In some embodiments of this application, before S101 of generating, based on task prompt information corresponding to a target task in a service scenario, a system interaction parameter corresponding to the target task in FIG. 3, the method may further include the following processing (S106 to S108).

S106. Determine a task definition prompt based on a task definition of the target task in the service scenario.

In the embodiments of this application, the electronic device may automatically construct the task prompt information for the target task. First, the electronic device first obtains the task definition of the target task. The task definition may describe specific content and a task requirement of the target task, for example, describe processing performed by the target task, or a condition that needs to be met by the target task in a processing process. Then, the electronic device performs prompt information generation for the task definition, and the obtained prompt information is the task definition prompt.

The task definition of the target task may be specified by a definition text of the natural language when the target task is created, so that the electronic device may perform semantic parsing based on the definition text, to obtain a definition of the target task. For example, when the definition text is "Query for an account matching an input condition," the electronic device may use "Query for a UID meeting a condition" as the task definition. Alternatively, key string extraction may be performed on the definition text, and the extracted key string is used as the definition of the target task.

In some embodiments of this application, S106 of determining a task definition prompt based on a task definition of the target task in the service scenario in FIG. 6 may be implemented by using the following processing: performing matching in an indication template library on the task definition of the target task in the service scenario, and determining a matched indication as the task definition prompt. In this case, determining of the task definition prompt is completed.

The electronic device may use, in the indication template library, an indication of information including the task definition, for example, an indication including key strings or language information of the task definition, as an indication matching the task definition, to obtain the task definition prompt. The electronic device may alternatively use, in the indication template library, an indication including all content of an entire task definition as an indication matching the task definition, to obtain the task definition prompt.

The indication template library includes various indications, which may be indications of historical tasks, frequently used indications with a use frequency greater than a specified frequency, indications determined based on a preset service functions in service scenarios, a combination of the foregoing, or the like. This is not limited in the embodiments of this application.

In some embodiments of this application, S106 of determining a task definition prompt based on a task definition of the target task in the service scenario in may further be implemented by using the following processing: performing format adjustment on the task definition based on a preset format of a prompt, to obtain the task definition prompt.

In other words, the prompt usually has a specific format, and the electronic device adjusts the task definition based on the format, and determines an adjusted result as the task definition prompt. The adjustment may include character alignment, standard language conversion, and the like (for example, converting Chinese to English).

S107. Extract task input data of the target task from scenario data of the service scenario, and generate a task input prompt for the target task based on the task input data.

The electronic device obtains data involved in the service scenario, to obtain the scenario data of the service scenario. Then, the electronic device extracts, from the obtained scenario data, data required for executing the target task, and uses the data as the task input data of the target task. Next, the electronic device constructs an input prompt for the target task by using the task input data, to obtain a corresponding task input prompt.

In some embodiments, the electronic device may integrate the extracted task input data into one natural language text, and use the text as the task input prompt. For example, when the task input data is "female," "under the age of 30," "traveling," "reading," and "gourmet food," the electronic device may use" females under 30 years old who like reading, traveling, and gourmet " as the task input prompt. In some embodiments, in some embodiments, the electronic device may alternatively directly use the extracted task input data as the task input prompt. This is not limited in the embodiments of this application.

S108. Determine an integrated result of the task definition prompt and the task input prompt as the task prompt information.

After obtaining the task definition prompt and the task input prompt, the electronic device may integrate the task definition prompt and the task input prompt into one text or into one sentence, and the integrated text or sentence is the task prompt information.

In some embodiments, in addition to the task definition prompt and the task input prompt, the task prompt information may further include some other prompts, for example, a task output prompt.

In some embodiments of this application, after S107 of extracting task input data of the target task from scenario data of the service scenario, and generating a task input prompt for the target task based on the task input data in FIG. 6, the task processing method may further include the following processing: generating a task output prompt for the target task based on a preset reply style of the target task; and determining an integrated result of the task definition prompt, the task input prompt, and the task output prompt as the task prompt information.

The preset reply style is configured for constraining a style of the processing result for the target task. Therefore, in the embodiments of this application, the electronic device may constrain the style of the processing result for the target task by using the preset reply style, so that the processing result for the target task can be standardized.

In some embodiments, in addition to the constraint on the style of the processing result, the preset reply style may further have other content, and this part of content may be configured for indicating a start position of the output information, or may be configured for being combined with the output information into a sentence in the form of natural language.

On this basis, after S102 of invoking a task system of the target task, to process the system interaction parameter in FIG. 3, the task method may further include the following processing: determining the processing result corresponding to the target task based on the output information of the task system of the target task for the system interaction parameter, and the task output prompt in the task prompt information.

In other words, when the task output prompt exists in the task prompt information, the electronic device processes the output information based on the task output prompt, so that the obtained processing result conforms to a constraint of the preset reply style, to improve the standardization of the processing result.

In some embodiments of this application, the determining the processing result corresponding to the target task based on the output information of the task system of the target task for the system interaction parameter, and the task output prompt in the task prompt information may be implemented by using the following processing: completing a masked part in the task output prompt by using the output information of the task system of the target task for the system interaction parameter, and determining the completed task output prompt as the processing result corresponding to the target task.

In the embodiments of this application, in the task output prompt, a to-be-filled masked part is reserved for the output information of the task system for the system interaction parameter. The electronic device replaces the masked part with the output information, to complete the task output prompt, and the completed task prompt information is the final processing result for the target task.

For example, the task output prompt may be "The UID you want to query=[mask] (referred to as the masked part)." If the output information of the task system for the system interaction parameter is 1000, the final processing result for the target task may be "The UID you want to query=1000."

In some embodiments of this application, the determining the processing result corresponding to the target task based on the output information of the task system of the target task for the system interaction parameter, and the task output prompt in the task prompt information may further be implemented by using the following processing: generating a natural language text for the output information based on a requirement of the task output prompt, and determining the generated text as the processing result for the target task.

In other words, the task output prompt specifies a condition of a to-be-presented natural language text, and the electronic device directly uses the natural language text generated for the output information based on the condition as the final processing result.

For example, the task output prompt may be that "Display the output information, with some descriptions added based on the output information of the task system to indicate that the output information has been obtained." In this case, the electronic device may generate a text "The requested processing has been completed, and the obtained result is UID=1000" for the output information. The text is the processing result for the target task.

In the embodiments of this application, the electronic device may combine the output information and the task output prompt, to obtain a processing result with an intuitive semantic feature. Therefore, the processing result can be easily applied to tasks to be displayed and described in the form of natural language, thereby increasing the variety of task processing that can be performed on data in the service scenario.

An exemplary application of the embodiments of this application in an actual application scenario is described below. The exemplary application describes a task of recommending a social account in a social application.

The exemplary application provided in the embodiment of this application is implemented in a scenario involving expansion of social relationships and points of interest. Therefore, the exemplary application provided in the embodiments of this application includes two different social distribution tasks. One is friend recommendation for a social scenario (referred to as a target task), and the other is content recommendation for an interest expansion scenario (referred to as a target task).

First, an overall system architecture used when social relationships and points of interest in the embodiments of this application are expanded is described.

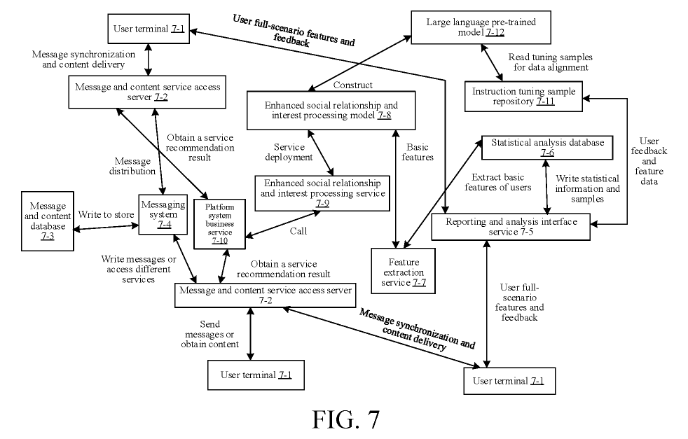

FIG. 7 is a schematic diagram showing a system architecture for expansion of social relationships and points of interest according to an embodiment of this application. Referring to FIG. 7, the system includes a plurality of user terminals 7-1 (three are shown exemplarily), a message and content service access server 7-2, a message and content database 7- 3, a messaging system 7-4, a reporting and analysis interface service 7-5, a statistical analysis database 7-6, a feature extraction service 7-7, an enhanced social relationship and interest processing model 7-8, an enhanced social relationship and interest processing service 7-9, a platform system business service 7-10, an instruction tuning sample repository 7-11, and a large language pre-trained model 7-12.

The user terminal 7-1 communicates with the message and content service access server 7-2 to send messages or obtain content (also referred to as message synchronization and content delivery), to implement both upstream and downstream messaging functions. In addition, the content producer such as PGC or UGC provides content to be distributed, for example, photographed videos and images and texts, by using a mobile terminal or a backend interface API. The user terminal 7-1 is a carrier of functions in various scenarios. When publishing content, the user terminal 7-1 obtains an interface address of an upload server, and then uploads a local file. The user terminal 7-1 communicates with the reporting and analysis interface service 7-5, to implement reporting of user full-scenario features and feedback, that is, collecting feature data of each sub-service scenario in different full-service scenarios.

The message and content service access server 7-2 is configured to: synchronize messages and deliver content to the user terminal 7-1; connect the messages and content to the message and content database 7-3 by using the messaging system 7-4, to write the messages or access different services; and communicate with the user terminal 7-1, directly access a server end by using the server to content submitted by the user terminal 7-1, for example, information such as a title, a publisher, an abstract, a cover image, and publishing time of the content or a file size, a cover image link, a code rate, a file format, a title, publishing time, and an author of the video, and store the content into the message and content database 7-3, to implement writing and storage of the information.

The message and content database 7-3 is configured to: temporarily store the messages of the user terminal 7-1, and implement message roaming and multi-terminal synchronization; save original meta-information of the content; and save the meta information (for example, information such as a file size, a code rate, a rule, and a cover image) obtained after a standard transcoding operation is performed on the content.

The messaging system 7-4 is configured to communicate with the message and content service access server 7-2, to implement message distribution.

The reporting and analysis interface service 7-5 communicates with the user terminal 7-1, to receive reported user full-scenario features and feedback, for example, reports and feedback about content delivery quality; and writes statistical information and samples to the statistical analysis database 7-6.

The statistical analysis database 7-6 is configured to: connect with the reporting and analysis interface service 7-5, to save messages and content obtained through desensitization processing, and perform initial processing, such as cleaning and verification, on data of different sub-service scenarios; and analyze points of interest of users based on data (for example, social data, behavior data, and attribute data of users and content) of different sub-service scenarios.

The feature extraction service 7-7 is configured to: extract basic features of users, for example, features such as age, gender, and education background, based on data in the statistical analysis database 7-6; and use the extracted basic features as data sources for constructing the enhanced social relationship and interest processing models 7-8.

The enhanced social relationship and interest processing model 7-8 is constructed by using the large language pre-trained model 7-12, that is, is a model obtained by injecting constructed prompts (referred to as task prompt information) into the large language pre-trained model 7-12. Inputs of the prompts during construction include social relationships, social relationship pairs, points of interest, basic features, and related descriptions of users, dialogue query history of users, and preset reply result styles (referred to as preset reply styles).

The enhanced social relationship and interest processing service 7-9 refers to a service obtained by deploying the enhanced social relationship and interest processing model 7-8 as a service.

The platform system business service 7-10 generally refers to an operating system of a platform, for example, a content recommendation system, a friend recommendation system, and a targeted delivery system. When working, the platform system business service 7-10 invokes the enhanced social relationship and interest processing service 7-9, to obtain a service recommendation result (referred to as a processing result), and delivers the service recommendation result by using the message and content service access server 7-2.

The instruction tuning sample repository 7-11 is configured to obtain feedback and feature data of users from the reporting and analysis interface service 7-5, to form sample pairs for natural language interaction access and actual generated results. The large language pre- trained model 7-12 may read tuning samples from the instruction tuning sample repository 7-11 to perform data alignment, that is, enhance a basic language model in a manner of instruction tuning, to ensure that the generated results can be applied by a social relationship system at a next level.

The large language pre-trained model 7-12 is a generative Transformer-based model constructed by using massive (greater than a specified amount of data) basic corpora. For example, a large language model LlaMa and a large language model GLM can both be used as the large language pre-trained model 7-12.

Processing of the enhanced social relationship and interest processing model is described below.

In this embodiment of this application, the enhanced social relationship and interest processing model is obtained by integrating the large language pre-trained model (referred to as the natural language processing model) and an existing social relationship system model (referred to as the task system). In this embodiment of this application, entries of the large language pre-trained model and the social relationship system model are merged together, so that the two models can work collaboratively, thereby absorbing and using advantages of the models. In addition, an online usage feedback result (referred to as benchmark scoring information) is introduced to the large language pre-trained model through RLHF, so that an output result can be aligned with an expected result.

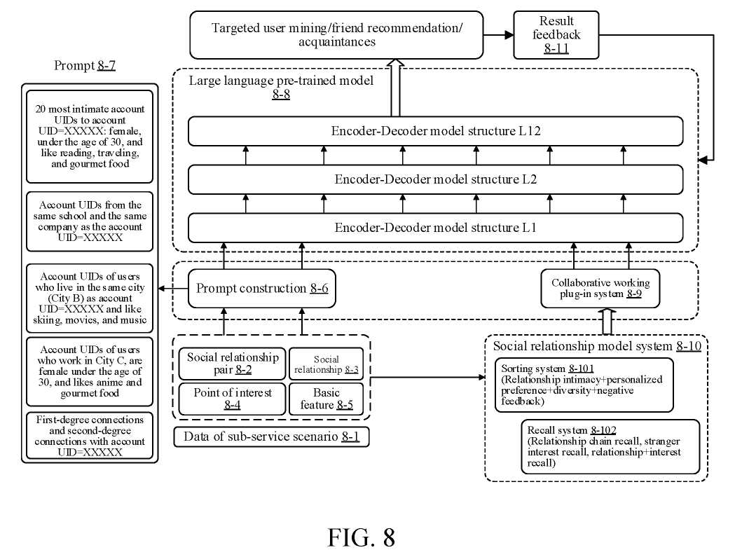

For example, FIG. 8 is a schematic diagram showing collaborative working between a large language pre-trained model and a social relationship system model according to an embodiment of this application. First, a social relationship pair 8-2, a social relationship 8-3, a point of interest 8-4, and a basic feature 8-5 of an account need to be extracted from data 8-1 of a sub-service scenario, then prompt construction 8-6 is performed based on the extracted information, and the constructed prompt 8-7 (referred to as task prompt information) is injected into a large language pre-trained model 8-8. Then, a social relationship model system 8-10 such as a sorting system 8-101 (performing sorting based on relationship intimacy+personalized preference+diversity+negative feedback) and a recall system 8-102 (performing relationship chain recall, stranger interest recall, and relationship+interest recall) is invoked by using a collaborative working plug-in system 8-9, a parameter instruction (referred to as a system interaction parameter) generated by the large language pre-trained model 8-8 for a prompt 8-7 is calculated by using the social relationship model system 8-10, and a calculation result is inputted to the large language pre-trained model 8-8 (including an encoder-decoder model structure (Transformers model structure) L1, an encoder-decoder model structure L2, and an encoder- decoder model structure L12) again, to obtain a recommendation result (referred to as a processing result) of targeted user mining/friend recommendation/acquaintances, and display the recommendation result. To improve the accuracy of task output, the large language pre-trained model 8-8 and a standard expected result are aligned before the model is officially launched. During alignment, a final result provided for an existing task (referred to as a training task) and result feedback 8-11 for the final result are invoked, to improve the result in a manner of reinforcement learning. For example, a scoring model (referred to as an evaluation model) is constructed through scoring scores in the result feedback 8-11. In an actual application process after the model is officially launched, a plurality of results (referred to as a plurality of pieces of output sub-information) outputted by the social relationship model system are scored by using the scoring model, and a result having a highest score is selected for output.

In some embodiments, in addition to the social relationship, the social relationship pair, the point of interest, and the basic information of the account, a construction input of the prompt 8-7 may further include an account history interaction content query and a preset reply result style (usually, detailed parameters such as a point of interest, a scenario, a location, a form of a target retrieval result, relationship intimacy, a location attribute, and a combination thereof are obtained based on a plug-in access protocol and required parameters of the social relationship model system). The constructed prompt is injected into the large language pre-trained model for debugging. After debugging and alignment, an inputted interaction instruction of natural language is converted into a corresponding parameter of the social relationship model system, and the parameter is invoked based on the plug-in access protocol and descriptions, to implement task execution.

The prompt 8-7 is described as follows.

The prompt may be classified into a task definition prompt (Task Definition Prompt), a task input prompt (Task Input Prompt), and a task output prompt (Task Output Prompt) in structure. A quantity of placeholders may be freely designed for each prompt. Herein, a quantity of placeholders of the task input prompt is usually greater than a quantity of placeholders of the task output prompt and greater than a quantity of placeholders of the task definition prompt. For example, the quantity of placeholders may be set to 1024.

The task definition prompt represents description prompt manners and requirements of all social relationships and interest enhancement task definitions, for example, related all social accounts, constraints on social accounts, or related points of interest and expansion of the points of interest. The task input prompt expresses information inputted by a task, for example, a mark of a social relationship of a social account, a social relationship pair, a point of interest of the social account, a basic feature of the social account, and descriptions thereof. The task output prompt is configured for defining a style and some content of a task output result, such as a UID, a point of interest, a scenario, a location, a form of a target retrieval result, relationship intimacy, a location attribute, and a combination thereof.

For examples, five examples of the prompt 8-7 are provided below.

1) 20 most intimate account UIDs to account UID=XXXXX: female, under the age of 30, and like reading, traveling, and gourmet food;

2) account UIDs from the same school and the same company as account UID=XXXXX;

3) account UIDs of users who live in the same city (City B) as account UID=XXXXX and likes skiing, movies, and music;

4) account UIDs of users who work in City C, are female under the age of 30, and like anime and gourmet food; and

5) first-degree connections and second-degree connections with account UID=XXXXX.

The social relationship model system in the embodiments of this application may be implemented by using a two-layer system. The two-layer system are respectively a graph storage layer and an operator operation layer. The graph storage layer is configured for storing a topology structure, node attribute information, a rapidly used index mechanism, and a cache mechanism of the graph network; and the operator operation layer may merge a basic operator of the GNN algorithm into an existing machine learning framework, to simplify a process of invoking the operator.

In the embodiments of this application, related data such as user information like social relationships, social relationship pairs, points of interest, and basic features is involved. When the embodiments of this application are applied to specific products or technologies, permission or consent of the user needs to be obtained, and collection, use, and processing of the related data need to comply with related laws, regulations, and standards of related countries and regions. In addition, in the embodiments of this application, regarding the implementation of the data grabbing technical solution, when the foregoing embodiments of this application are applied to specific products or technologies, related data collection, use, and processing processes need to comply with the requirements of national laws and regulations, conform to legal, justified, and necessary principles, do not involve obtaining data types prohibited or restricted by laws and regulations, and do not hinder normal running of related applications. In addition, during application of the related data collection and processing in the embodiments of this application, informed consent or separate consent of a personal information subject is to be strictly obtained in accordance with requirements of laws and regulations of related nations, and subsequent data use and processing are carried out within the scope of laws, regulations, and the authorization of the personal information subject.

The following further describes an exemplary structure of a task processing apparatus 255 provided in the embodiments of this application implemented as software modules. In some embodiments, as shown in FIG. 2, the software modules in the task processing 255 stored in the memory 250 may include:

a parameter generation module 2551, configured to generate, based on task prompt information corresponding to a target task in a service scenario, a system interaction parameter corresponding to the target task, the task prompt information being configured for describing the target task in a form of natural language, and the system interaction parameter being configured for describing the target task in a form of machine instructions;

a parameter processing module 2552, configured to invoke a task system of the target task, to process the system interaction parameter; and

a result determining module 2553, configured to determine a processing result corresponding to the target task based on output information of the task system of the target task for the system interaction parameter.

In some embodiments of this application, the parameter generation module 2551 is further configured to: perform semantic parsing on the task prompt information corresponding to the target task in the service scenario, to obtain a parsing result, a quantity of parameters of the natural language processing model being greater than a quantity threshold; and perform parameter generation on the parsing result, to obtain the system interaction parameter corresponding to the target task.

In some embodiments of this application, the output information includes a plurality of pieces of output sub-information; and the result determining module 2553 is further configured to: generate evaluation information for each piece of output sub-information; and filter a plurality of pieces of output sub-information based on the evaluation information, and determine the processing result corresponding to the target task based on the selected output sub- information.

In some embodiments of this application, the generation of the evaluation information is implemented by using an evaluation model, and the task processing apparatus 255 further includes a model generation module 2554, configured to: generate, based on training prompt information corresponding to a training task in a service scenario, a training interaction parameter corresponding to the training task; invoke a task system of the training task, to process the training interaction parameter; determine a plurality of training processing results corresponding to the training task based on a plurality of pieces of training output sub- information of the task system of the training task for the training interaction parameter; and based on a plurality of pieces of benchmark scoring information of the plurality of training processing results and a plurality of pieces of training scoring information generated by an initial model for the plurality of training processing results, train the initial model until the end of training, to obtain the evaluation model.

In some embodiments of this application, the result determining module 2553 is further configured to: generate a matching text for the output information of the task system of the target task for the system interaction parameter, the matching text being configured for describing the output information in the form of natural language; and determine the matching text as the processing result corresponding to the target task.

In some embodiments of this application, the task processing apparatus 255 further includes a prompt determining module 2555, configured to: obtain natural language information inputted for the target task in the service scenario; and determine the task prompt information corresponding to the target task in the service scenario based on the natural language information.

In some embodiments of this application, the prompt determining module 2555 is further configured to: determine a task definition prompt based on a task definition of the target task in the service scenario; extract task input data of the target task from scenario data of the service scenario; generate a task input prompt for the target task based on the task input data; and determine an integrated result of the task definition prompt and the task input prompt as the task prompt information.

In some embodiments of this application, the prompt determining module 2555 is further configured to: perform matching in an indication template library on the task definition of the target task in the service scenario, and determine a matched indication as the task definition prompt, to complete generation of the task definition prompt.

In some embodiments of this application, the prompt determining module 2555 is further configured to: generate a task output prompt for the target task based on a preset reply style of the target task, the preset reply style being configured for constraining a style of the processing result for the target task; and determine an integrated result of the task definition prompt, the task input prompt, and the task output prompt as the task prompt information.

In some embodiments of this application, the result determining module 2553 is further configured to: determine the processing result corresponding to the target task based on the output information of the task system of the target task for the system interaction parameter, and the task output prompt in the task prompt information.

In some embodiments of this application, the result determining module 2553 is further configured to: complete a masked part in the task output prompt based on the output information of the task system of the target task for the system interaction parameter; and determine the completed task output prompt as the processing result corresponding to the target task.

In some embodiments of this application, the parameter generation module 2551 is further configured to perform semantic parsing on the task prompt information by using a natural language processing model, a quantity of parameters of the natural language processing model being greater than a quantity threshold.

In some embodiments of this application, the result determining module 2553 is further configured to generate the matching text by using the natural language processing model.

An embodiment of this application provides a computer program product, the computer program product including a computer program or computer-executable instructions, the computer program or the computer-executable instructions being stored in a computer- readable storage medium. A processor of an electronic device reads the computer program or the computer-executable instructions from the computer-readable storage medium, and executes the computer program or the computer-executable instructions, to cause the electronic device to perform the foregoing task processing method in the embodiments of this application.

An embodiment of this application provides a computer-readable storage medium having a computer program or computer-executable instructions stored therein, the computer program or the computer-executable instructions, when executed by a processor, causing the processor to perform the task processing method in the embodiments of this application, for example, the task processing method shown in FIG. 3.

In some embodiments, the computer-readable storage medium may be a memory such as an FRAM, a ROM, a PROM, an EPROM, an EEPROM, a flash memory, a magnetic surface memory, an optical disk, or a CD-ROM; or may be any device including one of or any combination of the foregoing memories.

In some embodiments, the computer-executable instructions may be written in a form of a program, software, a software module, a script, or code and according to a programming language (including a compiled or interpreted language or a declarative or procedural language) in any form, and may be deployed in any form, including an independent program or a module, a component, a subroutine, or another unit suitable for use in a computing environment.

For example, the computer-executable instructions may, but do not necessarily, correspond to a file in a file system, and may be stored in a part of a file that saves another program or other data, for example, be stored in one or more scripts in a hypertext markup language (HTML) file, stored in a file that is specially configured for a program in discussion, or stored in a plurality of collaborative files (for example, be stored in files of one or more modules, subprograms, or code parts).

In an example, the computer-executable instructions may be deployed to be executed on an electronic device, or deployed to be executed on a plurality of electronic devices at the same location, or deployed to be executed on a plurality of electronic devices that are distributed in a plurality of locations and interconnected by using a communication network.

In conclusion, according to the embodiments of this application, task processing on the target task can be triggered and completed based on only natural language instructions, eliminating the need for code development for the target task. This not only reduces the time required for code development, and enables faster initiation of task processing on the target task, thereby improving the efficiency of task processing, but also reduces the operation difficulty of task processing as the natural language instructions are easier to generate and process thereby further compared with code. Further, in the embodiments of this application, when a combination of the service scenario and data changes, that is, a task that needs to be processed changes, only the task prompt information of the natural language needs to be changed. In this way, various tasks can be normally processed, thereby expanding the range of tasks that can be processed. Semantic parsing is performed on the task prompt information by using the natural language processing model, to eliminate semantic differences of the same data in different service scenarios, which can improve the accuracy of the parsing result.

The foregoing descriptions are merely embodiments of this application and are not intended to limit the protection scope of this application. Any modification, equivalent replacement, or improvement made without departing from the spirit and range of this application shall fall within the protection scope of this application.

What is claimed is:

1. A task processing method, performed by an electronic device, comprising:
generating, based on task prompt information corresponding to a target task in a service scenario, a system interaction parameter corresponding to the target task, the task prompt information describing the target task in a form of natural language, and the system interaction parameter describing the target task in a form of machine instructions;
invoking a task system of the target task, to process the system interaction parameter; and
determining a processing result corresponding to the target task based on output information of the task system for the system interaction parameter.

2. The method according to claim 1, wherein generating the system interaction parameter includes:
performing semantic parsing on the task prompt information to obtain a parsing result;
and performing parameter generation on the parsing result, to obtain the system interaction parameter.

3. The method according to claim 2, wherein the semantic parsing is implemented using a natural language processing model, and a quantity of parameters of the natural language processing model is greater than a quantity threshold.

4. The method according to claim 1, wherein:
the output information includes a plurality of pieces of output sub-information; and
determining the processing result includes: generating evaluation information for each of the plurality of pieces of output sub- information; filtering the plurality of pieces of output sub-information based on the evaluation information to obtain selected output sub-information; and determining the processing result corresponding to the target task based on the selected output sub-information.

5. The method according to claim 4, wherein the generation of the evaluation information is implemented using an evaluation model, and the evaluation model is obtained through following processing:
generating, based on training prompt information corresponding to a training task in the service scenario, a training interaction parameter corresponding to the training task;
invoking a task system of the training task, to process the training interaction parameter;
determining a plurality of training processing results corresponding to the training task based on a plurality of pieces of training output sub-information of the task system of the training task for the training interaction parameter; and
based on a plurality of pieces of benchmark scoring information of the plurality of training processing results and a plurality of pieces of training scoring information generated by an initial model for the plurality of training processing results, training the initial model to obtain the evaluation model.

6. The method according to claim 1, wherein determining the processing result includes:
generating a matching text for the output information, the matching text describing the output information in the form of natural language; and
determining the matching text as the processing result.

7. The method according to claim 6, wherein the generation of the matching text is implemented using a natural language processing model.

8. The method according to claim 1, further comprising, before generating the system interaction parameter:
obtaining natural language information inputted for the target task in the service scenario;
and determining the task prompt information based on the natural language information.

9. The method according to claim 1, further comprising, before generating the system interaction parameter:
determining a task definition prompt based on a task definition of the target task;
extracting task input data of the target task from scenario data of the service scenario;
generating a task input prompt for the target task based on the task input data; and
determining an integrated result of the task definition prompt and the task input prompt as the task prompt information.

10. The method according to claim 9, wherein determining the task definition prompt includes:
performing matching in an indication template library on the task definition; and
determining a matched indication as the task definition prompt.

11. The method according to claim 9, further comprising, after generating the task input prompt:
generating a task output prompt for the target task based on a preset reply style of the target task, the preset reply style constraining a style of the processing result; and
determining an integrated result of the task definition prompt, the task input prompt, and the task output prompt as the task prompt information.

12. The method according to claim 11, wherein determining the processing result includes:
determining the processing result based on the output information of the task system and the task output prompt in the task prompt information.

13. The method according to claim 12, wherein determining the processing result based on the output information of the task system and the task output prompt in the task prompt information includes:
completing a masked part in the task output prompt based on the output information of the task system to obtain a completed task output prompt as the processing result.

14. An electronic device comprising:
a memory storing a computer program or computer-executable instructions; and
a processor configured to execute the computer program or the computer-executable instructions to: generate, based on task prompt information corresponding to a target task in a service scenario, a system interaction parameter corresponding to the target task, the task prompt information describing the target task in a form of natural language, and the system interaction parameter describing the target task in a form of machine instructions; invoke a task system of the target task, to process the system interaction parameter; and determine a processing result corresponding to the target task based on output information of the task system for the system interaction parameter.

15. The electronic device according to claim 14, wherein the processor is further configured to execute the computer program or the computer-executable instructions to, when generating the system interaction parameter:
perform semantic parsing on the task prompt information to obtain a parsing result; and
perform parameter generation on the parsing result, to obtain the system interaction parameter.

16. The electronic device according to claim 15, wherein the semantic parsing is implemented using a natural language processing model, and a quantity of parameters of the natural language processing model is greater than a quantity threshold.

17. The electronic device according to claim 14, wherein:
the output information includes a plurality of pieces of output sub-information; and
the processor is further configured to execute the computer program or the computer- executable instructions to, when determining the processing result includes: generate evaluation information for each of the plurality of pieces of output sub- information; filter the plurality of pieces of output sub-information based on the evaluation information to obtain selected output sub-information; and determine the processing result corresponding to the target task based on the selected output sub-information.

18. The electronic device according to claim 17, wherein the generation of the evaluation information is implemented using an evaluation model, and the evaluation model is obtained through following processing:
generating, based on training prompt information corresponding to a training task in the service scenario, a training interaction parameter corresponding to the training task;
invoking a task system of the training task, to process the training interaction parameter;
determining a plurality of training processing results corresponding to the training task based on a plurality of pieces of training output sub-information of the task system of the training task for the training interaction parameter; and
based on a plurality of pieces of benchmark scoring information of the plurality of training processing results and a plurality of pieces of training scoring information generated by
an initial model for the plurality of training processing results, training the initial model to obtain the evaluation model.

19. The electronic device according to claim 14, wherein the processor is further configured to execute the computer program or the computer-executable instructions to, when determining the processing result includes:
generate a matching text for the output information, the matching text describing the output information in the form of natural language; and
determine the matching text as the processing result.

20. A non-transitory computer-readable storage medium storing a computer program or computer-executable instructions that, when executed by a processor, cause an electronic device including the processor to:
generate, based on task prompt information corresponding to a target task in a service scenario, a system interaction parameter corresponding to the target task, the task prompt information describing the target task in a form of natural language, and the system interaction parameter describing the target task in a form of machine instructions;
invoke a task system of the target task, to process the system interaction parameter; and
determine a processing result corresponding to the target task based on output information of the task system for the system interaction parameter.
